(19) United States
(12) Patent Application Publication
(10) Pub. No.: US 2009/0020079 A1
(43) Pub. Date: Jan. 22, 2009

(54) CIRCULATION SYSTEM, MIXING ELEMENT

(75) Inventors: Rolf Muller, Ludwigsburg (DE); Eberhard Pantow, Moglingen (DE); Sarah Parmentier, Bietigheim-Bissingen (DE); Eike Willers, Stuttgart (DE)

Correspondence Address: FOLEY AND LARDNER LLP;SUITE 500, 3000 K STREET NW, WASHINGTON, DC, 20007, US

(73) Assignees: BEHRmbH & Co. KG; BEHR THERMOT-TRONIK GmbH

(21) Appl. No.: 12/093,173

(22) PCT Filed: Nov. 10, 2006
(86) PCT No.: PCT/EP2006/010787

§ 371 Date: Sep. 24, 2008

(30) Foreign Application Priority Data
Nov. 10, 2005 (DE) 10 2005 053 983.1

(51) Int. Cl. F01P 7/16; F02B 29/04

(52) U.S. Cl. 123/41.1; 236/34.5; 123/563

(57) ABSTRACT

The invention relates to a circulation system with at least one first partial flow which can flow through a first heat exchanger and a second partial flow of a first medium. According to the invention, said system comprise also at least one second heat exchanger, in particular a charge air cooler, which can be penetrated by a first media flow, and at least one adjustable mixing element which can be penetrated, on the inflow side, by a first partial flow and/or a second partial flow and, on the outflow side, generates the media flow with a target temperature.

The present invention relates to a circulation system having at least a first partial flow which can flow through a first heat exchanger, and a second partial flow of a first medium, having at least a second heat exchanger, in particular having a charge air cooler, which can be supplied with a first medium flow, having at least one controllable mixing element which can be supplied at the inflow end with the first partial flow and/or the second partial flow, and at the outflow end generates the medium flow at a target temperature.

In addition, the invention relates to a mixing element for controlling the temperature of a medium flow, having at least a first inlet for a first partial flow of a medium at a first temperature, having a second inlet for a second partial flow at a second temperature and having at least one outlet for the medium flow, having at least one expansion element by means of whose expansion a respective valve setting of a valve body can be set, wherein a respective target temperature of the medium flow is assigned to a respective setting of the valve body, wherein the expansion of the expansion element can be controlled with at least one electric current.

In utility vehicles, the charge air is cooled directly, in particular with cooling air. In passenger cars, although indirect charge air cooling occurs a separate circuit with an additional electric pump is set. This pump is usually not regulated, i.e. it is either on or off. However, it can also be regulated.

DE 10 2004 060 658 A1 discloses a circulation system having a low-temperature coolant circuit for cooling charge air in a motor vehicle having a supercharging device with a charge air/coolant cooler, wherein a temperature sensor at the coolant outlet of the charge air/coolant cooler or just after it is provided for measuring the coolant outlet temperature. This permits coolant flow control as a function of the coolant outlet temperature of the coolant from the charge air/coolant cooler. In this context, the sensor can be integrated into the outlet from the charge air/coolant cooler or else can be arranged just downstream of the charge air/coolant cooler, in which case the distance from the charge air/coolant cooler should be as small as possible in order to ensure optimum, and in particular fast, control.

The temperature can be determined directly by means of a temperature sensor which is embodied as a thermostat and as a result of this configuration there is no need for a separately embodied control valve or for some other device for controlling the coolant volume flow. If a simple temperature sensor is provided, the coolant volume flow is controlled by reference to the measured value by means of a control valve or some other device for controlling the volume flow of the coolant. In this context, the control valve or the like can be arranged upstream of a low-temperature coolant cooler and upstream of the charge air/coolant cooler. Alternatively, it can also be arranged downstream of the temperature sensor.

In the case of direct charge air cooling, it is not advantageous to condition the intake air. The charge air is correspondingly cooled in accordance with the throughflow of cooling air. The direct charge air cooler is configured in such a way that the desired cooling occurs only for full-load operating points.

In contrast to direct charge air cooling, the intake air can be conditioned by controlling the throughput rate of coolant. However, on its own this is not particularly advantageous.

The object of the present invention is to improve a circulation system of the described type.

The object is achieved by means of the features of claim 1.

According to the invention, a circulation system is provided having at least a first partial flow which can flow through a first heat exchanger, in particular a low-temperature coolant cooler, and a second partial flow of a first medium, in particular of a cooling medium, having at least a second heat exchanger, in particular having a charge air cooler, which can be supplied with a first medium flow, having at least one controllable mixing element which can be supplied at the inflow end with the first partial flow and/or the second partial flow, and at the outflow end generates the medium flow at a target temperature.

Further advantageous embodiments of the invention emerge from the subclaims and from the drawing.

In one advantageous development, the circulation system has at least a second medium flow, in particular a charge air flow, which can be supplied to at least a first compressor, at least to a first turbine, in which case, in particular, the compressor and the turbine can be coupled and to the second heat exchanger, wherein the second heat exchanger is arranged at the outflow end of the first compressor. The compressor and the turbine are particularly advantageously embodied so as to form a turbocharger.

In one advantageous embodiment, the first heat exchanger, in particular the charge air cooler, is arranged in a low-temperature circuit. The low-temperature circuit is at a lower temperature than the high-temperature circuit. With the high-temperature circuit, in particular a coolant circuit, with, for example, a coolant/air cooler, an internal combustion engine can be cooled particularly advantageously. A low-temperature circuit branches of from the high-temperature circuit, in which case the coolant can be particularly advantageously cooled further in a further heat exchanger, in particular coolant/air cooler, in particular it can be cooled below the temperature of the coolant in the high-temperature circuit.

In one advantageous development, the circulation system has a third heat exchanger, in particular a coolant cooler, which is arranged in a high-temperature circuit for cooling an internal combustion engine. The coolant cooler can particularly advantageously be supplied with a cooling fluid, in particular cooling water.

In one advantageous embodiment, the circulation system has at least one pump which is arranged, in particular, in the high-temperature circuit. In particular, the pump is a coolant pump which particularly advantageously pumps coolant through the high-temperature circuit and/or through the low-temperature circuit.

In a further advantageous design, the high-temperature circuit and the low-temperature circuit are fluidically connected. From the high-temperature circuit, which in particular flows through a high-temperature coolant cooler and particularly advantageously cools, in particular, an engine, has a branch to a low-temperature circuit. In this way, a fluidic connection is particularly advantageously formed between the high-temperature circuit and the low-temperature circuit.

In a further advantageous embodiment, the first partial flow can be branched off from the high-temperature circuit, in particular downstream of the pump, and forms the low-temperature circuit, in particular at least in certain sections. The first partial flow can particularly advantageously be branched off from the high-temperature circuit downstream of the pump in order to have a stable circuit.

In one advantageous development, the mixing element and the first heat exchanger, in particular an air/coolant cooler, can particularly advantageously be fluidically connected to the first partial flow. In particular, the mixing element can be supplied with the first partial flow, in particular after said partial flow has flowed through the first heat exchanger.

In a further advantageous design, the second partial flow can be branched off from the high-temperature circuit, in particular downstream of the pump, and in particular essentially immediately upstream of the internal combustion engine. In particular, by means of a junction downstream of the pump, the second partial flow can particularly advantageously be fed at high pressure to the mixing element. In particular the junction is particularly advantageously located directly upstream of the internal combustion engine since the second heat exchanger and the mixing element can particularly advantageously be arranged adjacent to or essentially in the vicinity of the internal combustion engine, in a way which is particularly economical in terms of installation space.

In a further advantageous embodiment, the mixing element is arranged, or can be arranged, essentially adjacent to the second heat exchanger. In particular, the control of the temperature of the first medium, in particular of the coolant, can particularly advantageously be changed or controlled particularly quickly and without delay.

In one advantageous development, the mixing element is embodied in one piece with the second heat exchanger. This is particularly advantageously economical in terms of installation space.

In a further advantageous embodiment, the mixing element is arranged essentially adjacent to the first heat exchanger.

In one advantageous development, the mixing element is formed in one piece with the first heat exchanger. This is particularly advantageously economical in terms of installation space.

In a further advantageous embodiment, at least one flow control valve is arranged at the outflow end of the second heat exchanger. The through-flow of coolant, in particular through the second heat exchanger, in particular through the charge air cooler, can particularly advantageously be controlled and/or varied and/or set.

In a further advantageous embodiment, the flow control valve is arranged at the inflow end of the second heat exchanger and at the outflow end of the mixing element. The through-flow of coolant, in particular through the second heat exchanger, in particular through the charge air cooler, can particularly advantageously be controlled and/or varied and/or set.

In one advantageous development, the circulation system has a fourth heat exchanger, in particular a charge air cooler, a second compressor and a second turbine, wherein in particular the second compressor can be coupled to the second turbine. In particular, the compressor and the turbine can particularly advantageously be coupled to form a turbocharger.

In a further advantageous embodiment, the fourth heat exchanger is arranged at the outflow end of the second compressor and at the inflow end of the first compressor. In particular, the compressor can particularly advantageously be supplied with a second medium, in particular charge air, and in this context the second medium can particularly advantageously be intermediately cooled through the fourth heat exchanger in a first stage. In particular, this particularly advantageously prevents condensation of the charge air.

In a further advantageous embodiment, the first medium flow can be branched off at the outflow end of the mixing element and/or of the flow control valve into a third partial flow and a fourth partial flow, wherein the second heat exchanger can be supplied with the third partial flow and/or the fourth heat exchanger can be supplied with the fourth partial flow, or vice versa.

In one advantageous development, a second mixing element is arranged essentially adjacent to the fourth heat exchanger and is fluidically connected to it. In this way, the temperature of the medium flow which can be supplied to the fourth heat exchanger can particularly advantageously be controlled and/or set.

In one advantageous embodiment, the second mixing element is embodied in one piece with the fourth heat exchanger. This is particularly advantageously economical in terms of installation space.

In one advantageous development, at least a second flow control valve is arranged at the outflow end of the fourth heat exchanger. In this way, the flow rate of a first medium, in particular cooling medium, through the fourth heat exchanger can be particularly advantageously controlled.

In a further advantageous embodiment, the second flow control valve is arranged at the inflow end of the fourth heat exchanger and at the outflow end of the second mixing element. In particular, the second mixing element and the flow control valve can be embodied in a way which is particularly economical in terms of installation space, in particular can be embodied as one physical unit.

According to the invention, in addition a circulation system is formed which has at least a first compressor, at least a second heat exchanger, in particular a charge air cooler which can be supplied with a first medium flow, in particular coolant flow, a second medium flow, in particular charge air flow, at least a third heat exchanger, in particular high-temperature coolant cooler, at least a first heat exchanger, in particular low-temperature coolant cooler, in which case the first heat exchanger and/or the third heat exchanger can be supplied with the first medium flow and the first medium flow branches into a first partial flow and into a second partial flow, wherein the first heat exchanger can be supplied with the first partial flow and can be bypassed by the second partial flow.

In one advantageous development of the circulation system according to claim 23, characterized in that a fourth heat exchanger and a second compressor can be supplied with the second medium flow, characterized in that the first medium flow branches into a third partial flow and a fourth partial flow, in which case the fourth heat exchanger can be supplied with the third partial flow, and the first heat exchanger can be supplied with the fourth partial flow.

According to the invention, a mixing element for controlling the temperature of a medium flow is also provided, said mixing element having at least a first inlet for a first partial flow of a medium at a first temperature, having a second inlet for a second partial flow at a second temperature and having at least one outlet for the medium flow, having at least one expansion element by means of whose expansion a respective valve setting of a valve body can be set, wherein a respective target temperature of the medium flow is assigned to a respective setting of the valve body, and in this context the expansion of the expansion element can be controlled with at least one electric current.

In one advantageous development, the valve body has at least one piston element with which a slider element can be particularly advantageously actuated.

In a further advantageous embodiment, the slider element has at least a first valve seat and at least a second valve seat.

In one advantageous development, the mixing element has at least one spring element with which the valve body can, in particular, be moved particularly advantageously into the first valve end position.

In a further advantageous embodiment, the valve body can be transferred from at least a first valve end position via at least an intermediate valve setting to at least a second valve end position.

In one advantageous development, in the first valve end position, the slider element particularly advantageously essentially completely closes the first inlet of the first partial flow with the first valve seat, in which case the second partial flow particularly advantageously forms the medium flow, and in particular the target temperature is equal to the second temperature.

In one advantageous embodiment, in the second valve end position, the slider element particularly advantageously essentially completely closes the second inlet of the second partial flow with the second valve seat, wherein the first partial flow forms the medium flow, and in particular the target temperature is equal to the first temperature.

In a further advantageous embodiment, in the intermediate valve setting, the slider element is arranged particularly advantageously between the first valve end position and the second valve end position, wherein the first partial flow at the first temperature enters via the first inlet and particularly advantageously mixes with the second partial flow which enters through the second inlet at the second temperature, and forms the medium flow with the target temperature.

A mixing element, in particular of the described type, is particularly advantageously used in a circulation system, in particular of the described type.

Exemplary embodiments of the invention are illustrated in the drawing and will be explained in more detail in the text which follows. In said drawing:

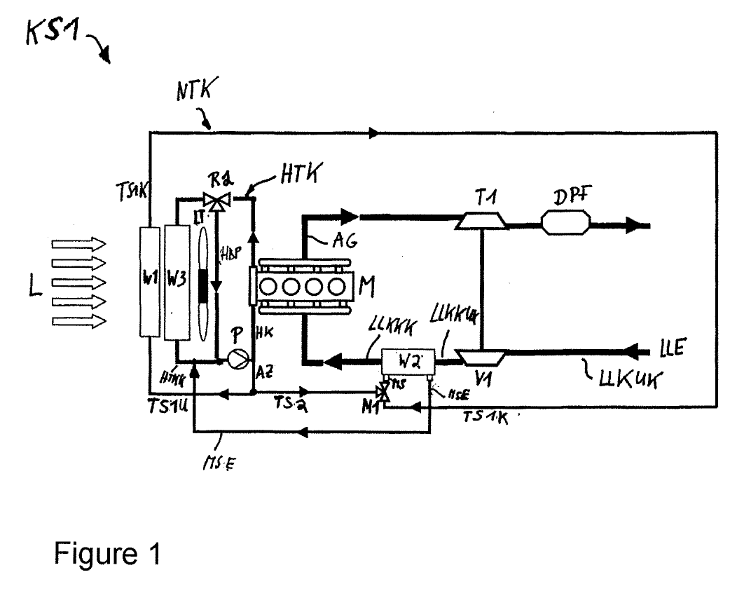

FIG. 1: shows the circulation system with single-stage supercharging,

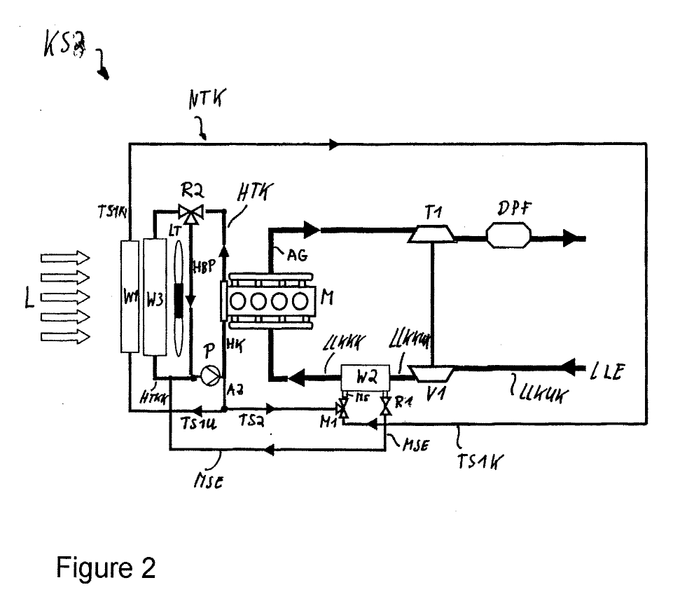

FIG. 2: shows a further exemplary embodiment of a circulation system with single-stage supercharging,

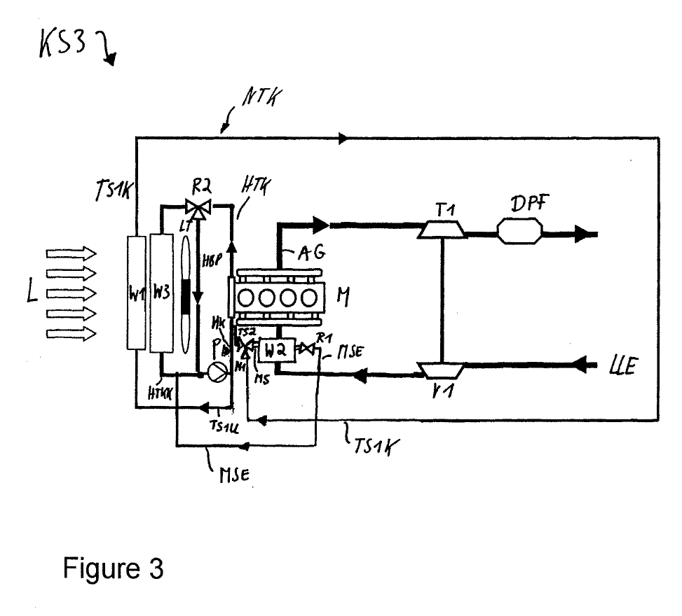

FIG. 3: shows a further exemplary embodiment of a circulation system with single-stage supercharging,

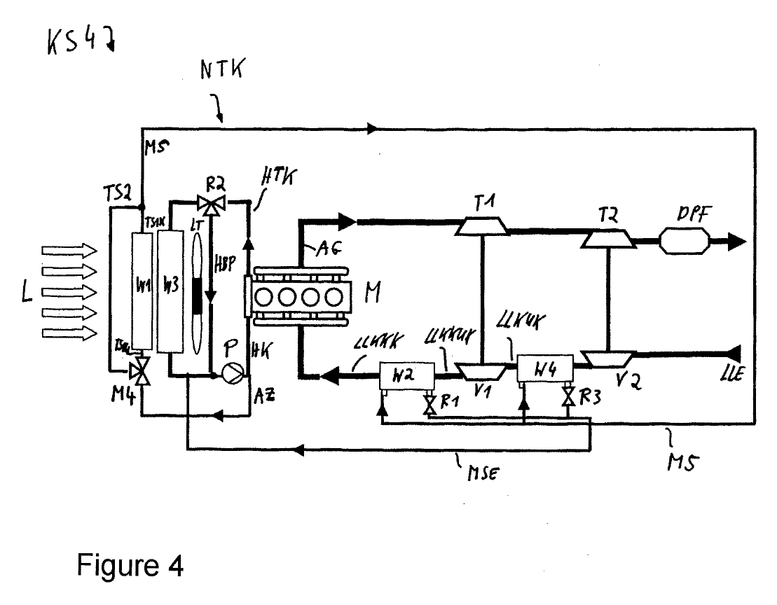

FIG. 4: shows a circulation system with two-stage supercharging, in particular flow control and/or temperature control,

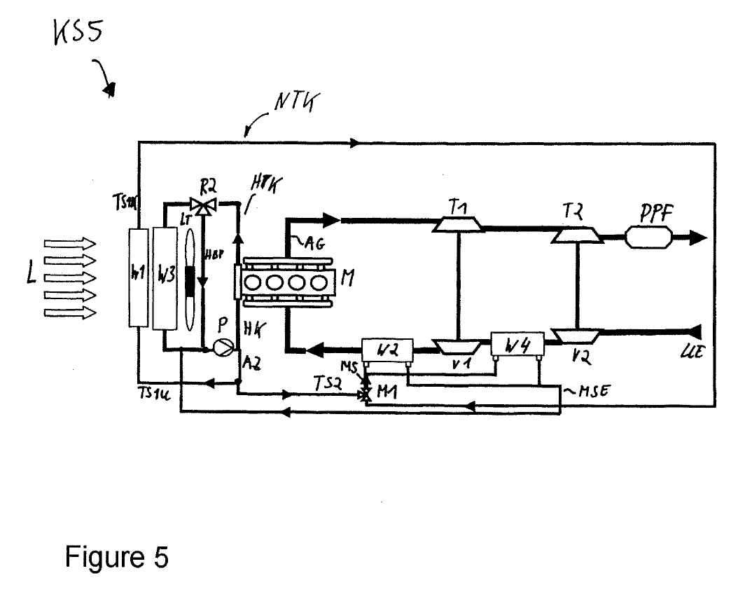

FIG. 5: shows a further exemplary embodiment of a circulation system with two-stage supercharging and with temperature control,

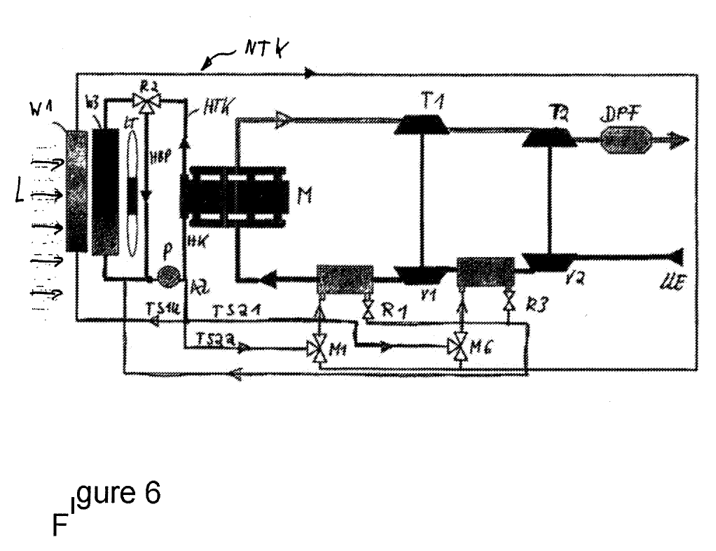

FIG. 6: shows a further exemplary embodiment of a circulation system with two-stage supercharging, in particular with condensate-avoidance control,

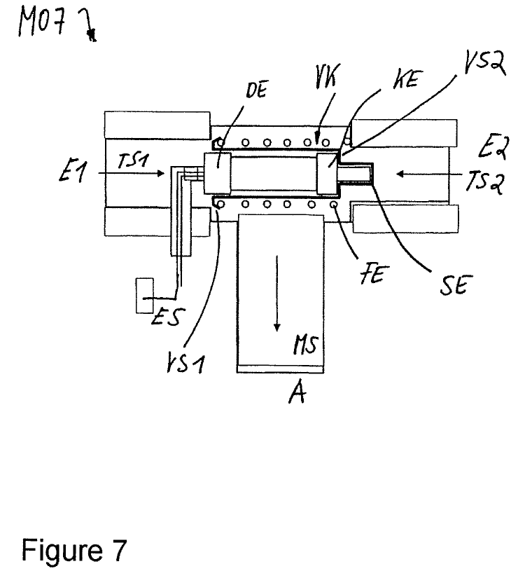

FIG. 7: shows a mixing element,

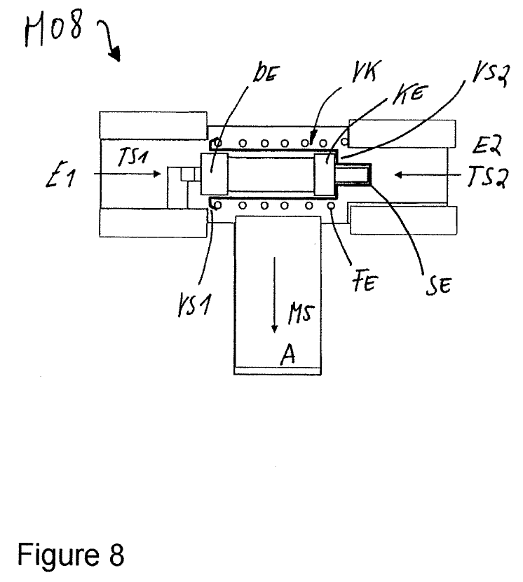

FIG. 8: shows a further exemplary embodiment of a mixing element,

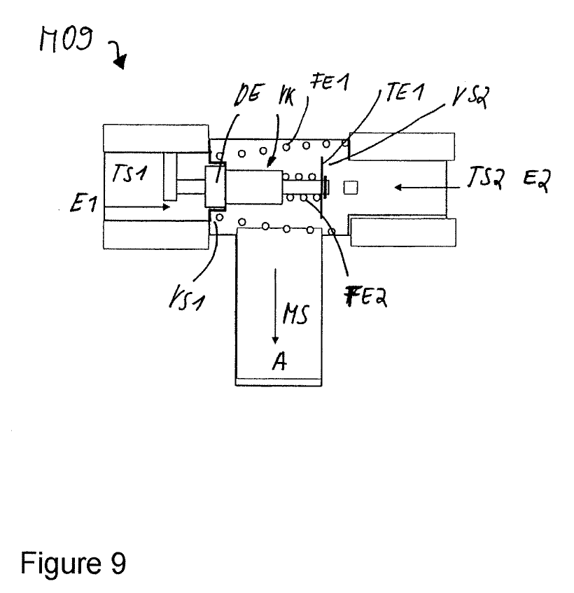

FIG. 9: shows a further exemplary embodiment of a mixing element, and

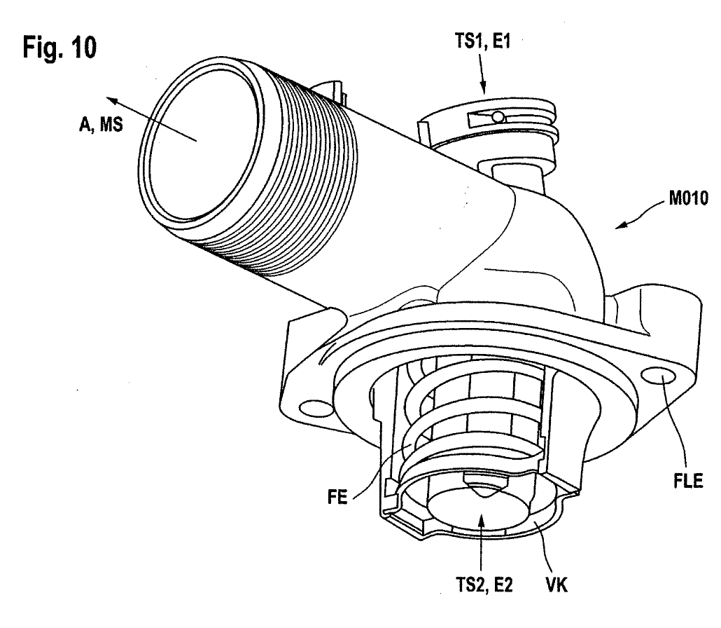

FIG. 10: is an isometric illustration of a mixing element.

FIG. 1 shows a circulation system with single-stage supercharging.

The circulation system KS1 has a high-temperature circuit HTK and a low-temperature circuit. In the high-temperature circuit HTK, a first medium, a liquid coolant, flows. The high-temperature circuit HTK has a third heat exchanger W3, in particular a coolant cooler, a control element R2 (for example a thermostat) and a pump P. The pump P pumps the first medium, in particular the liquid coolant, through the high-temperature circuit HTK, in particular also through the low-temperature circuit. In a high-temperature section HK, some of the first medium flows through an internal combustion engine M and cools it in the process. The first medium heats up in the process and flows through a control element R2. The control element R2 splits up the first medium flow, a high-temperature flow which is fed to a third heat exchanger W3, in particular a coolant cooler, flows through it and in the process is cooled, and a high-temperature bypass HBP which bypasses the heat exchanger W3. In this context, both the entirety of the coolant can flow uncooled through the high-temperature bypass HBP and no coolant can flow through the heat exchanger W3. In another switched setting of the control element R2, the entirety of the coolant flows through the heat exchanger W3 and no coolant flows through the high-temperature bypass HBP. In a further switched setting of the control element R2, a portion of the coolant flows through the high-temperature bypass HBP and a further portion flows through the third heat exchanger W3.

In particular, a first heat exchanger W1 is arranged upstream of the third heat exchanger W3. A fan is arranged downstream of the third heat exchanger W3. The fan rotates and in the process sucks in, in particular, air L, in particular exterior air, through the first heat exchanger W1 and through the third heat exchanger W3 and/or air flows through the first and/or third heat exchangers due to the travel speed.

The medium which is cooled by the third heat exchanger W3, in particular the cooling medium, flows into a flow section HTKK and is, if appropriate, joined with the uncooled first medium which flows through the high-temperature bypass HBP, wherein first medium which is heated before the joining and which is led off from the second heat exchanger W2, in particular the charge air cooler, is fed to the flow section HTKK. The joined coolant flows through a pump P and is in the process placed at a higher pressure level. After the coolant flow has flowed through a pump, it branches into the high-temperature section HK and a branch AZ.

The branch AZ forms the flow connection between the high-temperature circuit HTK and the low-temperature circuit NTK. The branch branches into a first partial flow TS1U of the first medium, in particular of the coolant, and into a second partial flow TS2.

The first partial flow TS1U flows through the first heat exchanger W1 and is cooled by the air and flows off from the heat exchanger W1 as a cooled flow of the first medium, in particular of the liquid coolant, TSLK. The cooled first partial flow of the first medium TSLK flows through the mixing element M1. The second partial flow TS2 of the first medium which is not cooled by the heat exchanger W1 also flows through the mixing element M1. The first partial flow TS1K is at a first temperature. The second partial flow TS2 is at a second temperature.

The mixing element M1 can be controlled in such a way that it can assume various settings. In a first setting of the mixing element M1 none of the medium which is cooled by W1 whatsoever is fed to the second heat exchanger but rather only uncooled medium of the second partial flow TS2 at the second temperature. The medium flow MS is therefore essentially the second partial flow TS2. The target temperature is essentially the second temperature. In another setting of the mixing element M1, only first medium which is cooled by the first heat exchanger W1 and fed to the mixing element M1 via the first partial flow TS1K is fed to the second heat exchanger W2. The medium flow MS is therefore essentially the first partial flow TS1K. The target temperature is essentially the first temperature. In further settings of the mixing element M1, the first partial flow TS1K at the first temperature is mixed with the second partial flow TS2 at the second temperature in such a way that the medium flow is at the target temperature. The target temperature can be controlled here in such a way that it meets the following condition: first temperature≦target temperature≦second temperature. The control of the target temperature is achieved by mixing cold and warm coolant. The mixing element M1 may be an inlet-controlled characteristic diagram-mixing thermostat and/or an electrically actuable valve and/or a three-piston valve and/or a plate valve and/or a model-based controller. A model-based controller is controlled, in particular, engine characteristic diagram. In particular when an inlet-controlled characteristic diagram-mixing thermostat is used, the thermostat can be open-loop and/or closed-loop controlled with the coolant temperature at the outlet of the charge air cooler and, for example, the coolant temperature at the outlet of the engine.

In a model-based mixing element M1, possible input variables are the engine load and/or the engine speed of the engine M and/or the coolant temperature at the outlet of the charge air cooler of the flow MSE and/or the counter pressure of the particle filter DPF.

All the embodiments of the mixing element M1 ensure the optimum intake air temperature at full load, partial load operating points and in the case of dynamic processes.

The mixing element is particularly advantageously arranged adjacent to the second heat exchanger W2, in particular adjacent to the charge air cooler, in order to be able to set the required coolant temperature immediately at the charge air cooler W2, in particular without a delay.

The lines between the mixing element M1 and the second heat exchanger W2 are to be made as short as possible. In particular, the mixing element is to be embodied in one piece with the heat exchanger. As a result, when there are load jumps of the engine M, no delays occur when there is a necessary adjustment of the coolant temperature at the inlet of the heat exchanger W2. This advantage in terms of functionality can also be achieved by integrating the mixing element into the charge air cooler. This integration provides additional advantages in terms of installation space. A mixing element in the form of an integral thermostat can be attached to the second heat exchanger by means of a flange. A hose thermostat can be attached using hose clips.

In other embodiments (not illustrated), the second heat exchanger can be an exhaust gas heat exchanger and/or an oil cooler and/or a coolant cooler and/or a condenser of an air conditioning system and/or a vaporizer of an air conditioning system.

The medium flow MS flows through the second heat exchanger W2 and leaves it heated as flow MSE.

The second heat exchanger cools, in particular, a second medium, in particular a gaseous medium, in particular charge air. The charge air is sucked in from the surroundings at an intake point LLE and flows through a first compressor V1 via a flow duct LLKUK, during which process the pressure of the second medium and the temperature are increased. In the second heat exchanger, the second medium flow is cooled and flows through the engine M via a line LLKKK. At a point (not illustrated), fuel is mixed with the compressed and cooled charge air and burnt in the engine M to form exhaust gas which is fed via an exhaust gas line to a first turbine T1 and then to a particle filter DPF. The turbine T1 is coupled to the compressor V1, in particular to form a turbocharger. The supercharging occurs in a single stage in the example illustrated but it can also occur in two stages.

FIG. 2 shows a further exemplary embodiment of a circulation system with single-stage supercharging. The same features are provided with the same reference symbols as in FIG. 1.

In contrast to FIG. 1, the circulation system has a flow control valve R1. The flow control valve R1, in particular the thermostat, is arranged at the downstream end of the second heat exchanger in the illustrated exemplary embodiment. The flow control valve R1, can, however, also be arranged at the outflow end of the mixing element M1 or at the inflow end of the second heat exchanger W2. In particular, the mixing element M1 and the flow control valve can be embodied in one piece, in particular in one physical unit.

FIG. 3 shows a further exemplary embodiment of a circulation system with single-stage supercharging. Identical features are provided with the same reference symbols as in the previous figures.

In the illustrated exemplary embodiment, the first partial flow TS1U flows off directly downstream of the pump and is fed to the first heat exchanger W1. The second partial flow TS2 is branched from the high-temperature section HK just before the engine M and fed to the mixing element M1. The second heat exchanger is in this way particularly advantageously arranged adjacent to the engine M, which is advantageously economical in terms of installation space.

FIG. 4 shows a circulation system with two-stage supercharging with control of the throughput rate and/or control of the temperature. Identical features are provided with the same reference symbols as in the preceding figures.

The circulation system KS4 has a second compressor V2 and a second turbine T2 which can, in particular, be coupled to form a turbocharger.

The second compressor V2 compresses the sucked-in charge air. A fourth heat exchanger W4 carries out intermediate cooling of the charge air. The first compressor V1 then compresses the charge air further, after which second cooling of the charge air occurs in the second heat exchanger W2. At the outflow end of W4, a flow control valve R3 is arranged. However, it can also be arranged at other locations, see in this respect the possible arrangements of the flow control valve R1.

A mixing element M4 can, in particular, be arranged at the inflow end of the first heat exchanger W1, in particular adjacent thereto. It can bypass the second partial flow TS2 at the heat exchanger W1 and/or fed the first partial flow TS1U to the first heat exchanger. The mixing element M4 is particularly advantageously integrated into the first heat exchanger. In particular, as a result the pressure which acts on the first heat exchanger M1 can be particularly advantageously limited. In particular, this can used particularly advantageously for limiting the pressure wave. In this way, the strength of the cooler is increased. At the same time, the integration of the mixing element into the heat exchanger permits savings in terms of materials, weight and costs since additional housing components for the mixing element are dispensed with.

FIG. 5 shows a further exemplary embodiment of a circulation system with two-stage supercharging and for the purpose of temperature control. Identical features have been provided with the same reference symbols as in the previous figures.

The medium flow MS is branched at the outflow end of the mixing element into a third partial flow which can be fed to the second heat exchanger and/or into a fourth partial flow which can be fed to the fourth heat exchanger W4. This makes the controlled system particularly short so that control can be carried out immediately, in particular without a delay. In particular, the second heat exchanger W2 and the fourth heat exchanger W4 are controlled at the same temperature.

FIG. 6 shows a further exemplary embodiment of a circulation system with two-stage supercharging in order to avoid the production of condensate. Identical features are provided with the same reference symbols as in the preceding figures.

The junction AZ divides here into the first partial flow TS1U, the second first partial flow TS21 and the second second partial flow TS22. TS21 is fed to the first mixing element M1. TS22 is fed to the second mixing element M6. The second mixing element M6 corresponds essentially to the design of the first mixing element M1. In particular charge air is prevented from condensing in the fourth heat exchanger W4 since the control system permits various temperatures to be reached, inter alia also a temperature at which condensate does not form.

FIG. 7 shows a mixing element. Identical features are provided with the same reference symbols as in the preceding figures.

The mixing element M07 controls, in particular, the temperature of a medium flow. It has a first inlet E1 for a first partial flow TS1 of a medium. The first partial flow TS1 is at a first temperature. The mixing element M07 has a second temperature E2 for a second partial flow TS2 with a second temperature. Furthermore, the mixing element M07 has an outlet A for the medium flow MS. A valve body VK is arranged in the mixing element. The valve body comprises an expansion element DE, a piston element KE. The valve body is embodied as a slider element SE. A respective valve setting of a valve body can be set by means of the expansion of the expansion element, in which case a respective target temperature of the medium flow MS is assigned to a respective setting of the valve body VK. The expansion of the expansion element DE can be controlled with at least one electric current ES. The expansion element is heated in particular by means of the electric current, expands and pushes a piston element KE. The piston element is movably arranged, and the expansion element is fixedly connected to the housing of the mixing element. In another embodiment, the expansion element can move and the piston can be fixedly connected to the mixing element. The mixing element has a spring element with which the valve body can be placed in a first end position. The mixing element can be placed in a first valve end position in which the slider element essentially completely closes, with the first valve seat, the first inlet of the first partial flow, and in which the second partial flow forms the media flow, and in particular the target temperature is equal to the second temperature.

The mixing element has a second valve end position in which the slider element can be placed, in which context the second inlet of the second partial flow can be essentially completely closed with the second valve seat, the first partial flow forms the media flow, and in particular the target temperature is equal to the first temperature.

The mixing element has an intermediate valve setting in which the slider element can be placed, which intermediate valve setting is arranged between the first valve end position and the second valve end position, in which case the first partial flow at the first temperature enters via the first inlet and mixes with the second partial flow which enters through the second inlet, at the second temperature, and forms the media flow with the target temperature.

FIG. 8 shows a further exemplary embodiment of a mixing element. Identical features are provided with the same reference symbols as in the preceding figures.

In contrast to FIG. 7, the mixing element M08 does not have any energization with ES but is instead open-loop and/or closed-loop controlled by means of the first temperature and/or the second temperature.

FIG. 9 shows a further exemplary embodiment of a mixing element. Identical features are provided with the same reference symbols as in the preceding figures.

In this embodiment, in addition to a first spring element FE1, a second spring element FE2 is arranged in the mixing element M09. A spring element TE1 forms the second valve seat and can close or open the second inlet E2. In this context, FE2 places the plate element in the second valve end position.

FIG. 10 shows an isometric illustration of a mixing element. Identical features are provided with the same reference symbols as in the preceding figures.

The mixing element M010 has a flange.

The features of the various exemplary embodiments can be combined with one another in any desired way. The invention can also be used for fields other than those shown.

1. Circulation system having
at least a first partial flow which can flow through a first heat exchanger,
and a second partial flow of a first medium,
at least a second heat exchanger, in particular a charge air cooler,
which can be supplied with a first medium flow,
at least one controllable mixing element, wherein
the controllable mixing element can be supplied at the inflow end with the first partial flow and/or the second partial flow, and at the outflow end generates the medium flow at a target temperature.

2. Circulation system according to claim 1, wherein the circulation system has at least a second medium flow, in particular a charge air flow, which can be supplied to at least a first compressor, at least to a first turbine, wherein in particular the compressor and the turbine can be coupled, and to the second heat exchanger, wherein the second heat exchanger is arranged at the outflow end of the first compressor.

3. Circulation system according to claim 1, wherein the first heat exchanger (W1) is arranged in a low-temperature circuit (NTK).

4. Circulation system according to claim 1, wherein the circulation system has a third heat exchanger, in particular a coolant cooler, which is arranged in a high-temperature circuit for cooling an internal combustion engine.

5. Circulation system according to claim 1, wherein the circulation system has at least one pump which is arranged, in particular, in the high-temperature circuit.

6. Circulation system according to claim 1, wherein the high-temperature circuit and the low-temperature circuit are fluidically connected.

7. Circulation system according to claim 1, wherein the first partial flow can be branched off from the high-temperature circuit, in particular downstream of the pump, and forms the low-temperature circuit, in particular at least in certain sections.

8. Circulation system according to claim 1, wherein the mixing element and the first heat exchanger, in particular an air/coolant cooler, can be fluidically connected to the first partial flow.

9. Circulation system according to claim 1, wherein the second partial flow can be branched off from the high-temperature circuit, in particular downstream of the pump, and in particular essentially immediately upstream of the internal combustion engine.

10. Circulation system according to claim 1, wherein the mixing element is arranged essentially adjacent to the second heat exchanger.

11. Circulation system according to claim 1, wherein the mixing element is embodied in one piece with the second heat exchanger.

12. Circulation system according to claim 1, wherein the mixing element is arranged essentially adjacent to the first heat exchanger.

13. Circulation system according to claim 1, wherein the mixing element is formed in one piece with the first heat exchanger.

14. Circulation system according to claim 1, wherein at least one flow control valve is arranged at the outflow end of the second heat exchanger.

15. Circulation system according to claim 1, wherein the flow control valve is arranged at the inflow end of the second heat exchanger and at the outflow end of the mixing element.

16. Circulation system according to claim 1, wherein the circulation system has a fourth heat exchanger, in particular a charge air cooler, a second compressor and a second turbine, wherein in particular the second compressor can be coupled to the second turbine.

17. Circulation system according to claim 1, wherein the fourth heat exchanger is arranged at the outflow end of the second compressor and at the inflow end of the first compressor.

18. Circulation system according to claim 16, wherein the first medium flow can be branched off at the outflow end of the mixing element and/or of the flow control valve into a third partial flow and a fourth partial flow, wherein the second heat exchanger can be supplied with the third partial flow and/or the fourth heat exchanger can be supplied with the fourth partial flow, or vice versa.

19. Circulation system according to claim 16, wherein a second mixing element is arranged essentially adjacent to the fourth heat exchanger and is fluidically connected to it.

20. Circulation system according to claim 16, wherein the second mixing element is embodied in one piece with the fourth heat exchanger.

21. Circulation system according to claim 16, wherein at least a second flow control valve is arranged at the outflow end of the fourth heat exchanger.

22. Circulation system according to claim 16, wherein the second flow control valve is arranged at the inflow end of the fourth heat exchanger and at the outflow end of the second mixing element.

23. Circulation system having
at least a first compressor,
at least a second heat exchanger, in particular a charge air cooler which can be supplied with a first medium flow, in particular coolant flow,
a second medium flow, in particular charge air flow,
at least a third heat exchanger, in particular high-temperature coolant cooler,
at least a first heat exchanger, in particular low-temperature coolant cooler,
wherein the first heat exchanger and/or the third heat exchanger can be supplied with the first medium flow, wherein the first medium flow branches into a first partial flow and into a second partial flow, wherein the first heat exchanger can be supplied with the first partial flow and can be bypassed by the second partial flow.

24. Circulation system according to claim 23, wherein a fourth heat exchanger and a second compressor can be supplied with the second medium flow, wherein the first medium flow branches into a third partial flow and a fourth partial flow, wherein the fourth heat exchanger can be supplied with the third partial flow, and the first heat exchanger can be supplied with the fourth partial flow.

25. Mixing element for controlling the temperature of a medium flow,
having at least a first inlet for a first partial flow of a medium at a first temperature,
having a second inlet for a second partial flow at a second temperature and having at least one outlet for the medium flow,
having at least one expansion element by means of whose expansion a respective valve setting of a valve body can be set,
wherein a respective target temperature of the medium flow is assigned to a respective setting of the valve body,
characterized in that the expansion of the expansion element can be controlled with at least one electric current.

26. Mixing element according to claim 25, wherein the valve body has at least one piston element with which a slider element can be actuated.

27. Mixing element according to claim 25, wherein the slider element has at least a first valve seat and at least a second valve seat.

28. Mixing element according to claim 25, wherein the mixing element has at least one spring element.

29. Mixing element according to claim 25, wherein the valve body can be transferred from at least a first valve end position via at least an intermediate valve setting to at least a second valve end position.

30. Mixing element according to claim 25, wherein, in the first valve end position, the slider element essentially completely closes the first inlet of the first partial flow with the first valve seat, wherein the second partial flow forms the medium flow, and in particular the target temperature is equal to the second temperature.

31. Mixing element according to claim 25, wherein, in the second valve end position, the slider element essentially completely closes the second inlet of the second partial flow with the second valve seat, wherein the first partial flow forms the medium flow, and in particular the target temperature is equal to the first temperature.

32. Mixing element according to claim 25, wherein, in the intermediate valve setting, the slider element is arranged between the first valve end position and the second valve end position, wherein the first partial flow at the first temperature enters via the first inlet and mixes with the second partial flow which enters through the second inlet at the second temperature, and forms the medium flow with the target temperature.

33. (canceled)

34. A circulation system comprising a mixing element according to claim 25.
